(19) United States
(12) Patent Application Publication
(10) Pub. No.: US 2026/0049596 A1
(43) Pub. Date: Feb. 19, 2026

(54) Internet of Things-based method and device for controlling power generation of wind power generator set

(71) Applicant: Zhongshan Power Supply Bureau of Guangdong Power Grid Co Ltd., Zhongshan City (CN)

(72) Inventors: Xiangfeng ZHOU, Zhongshan City (CN); Chunyuan CAI, Zhongshan City (CN); Yongjian LI, Zhongshan City (CN); Lifei LI, Zhongshan City (CN)

(73) Assignee: Zhongshan Power Supply Bureau of Guangdong Power Grid Co Ltd., Zhongshan City (CN)

(21) Appl. No.: 18/808,600

(22) Filed: Aug. 19, 2024

(30) Foreign Application Priority Data
Feb. 27, 2024 (CN) 202410214020.2

(51) Int. Cl. F03D 7/02

(52) U.S. Cl. CPC F03D 7/0272; F03D 7/0276; F05B 2270/1033; F05B 2270/3201; F05B 2270/321; F05B 2270/335

(57) ABSTRACT

A method and a device for controlling power generation of a wind power generation unit based on the Internet of Things are provide. According to the method, at least one of a first electric power generation power control amount component, a second electric power control amount component, and a third electric power control amount component is controlled. An expected adjustment value of electric power is determined, so that at least one of a gearbox step-up ratio, an electromagnetic torque of a generator, and a rotation speed of a wind wheel can be calculated to adjust a data security adjustment and control amount of output power of an offshore wind power generator set. The electric power generation power of the wind turbine generator set is adjusted to be the difference between the current electric power generation power and the expected adjustment value of the electric power generation power.

### TECHNICAL FIELD

The present application relates to the technical field of control of an offshore wind turbine, and in particular, to a method, device, medium and system for controlling electric power generation of a wind turbine based on the Internet of Things.

### BACKGROUND

Wind power belongs to an unstable energy source, is greatly affected by the wind speed, and the magnitude of the output force of a wind power field is also variable. Depending on the magnitude of the wind speed, particularly, there is a problem that the wind power field may be processed very little during a period of high peak load, while the wind power field may be processed very much during a period of non-peak load, and therefore, after being connected to a power grid, the wind power field will have a serious effect on the safe operation of the power grid. when the wind speed is less than the cut-in wind speed or greater than the cut-out wind speed, no output power exists in the wind power generation unit; when the wind speed is less than the rated wind speed for the cut-in wind speed, the output power of the wind power generator set is less than the rated power; when the wind speed is less than the cut-out wind speed for the rated wind speed, the wind power generator set outputs the rated power. In different seasons of a year, the wind speeds are completely different, and in different time periods of a day, the wind speeds are random, fluctuating and intermittent. Therefore, the wind speed of the small wind power plant is often expressed in expressions such as a minimum wind speed, a maximum wind speed, an average wind speed, a multi-year average wind speed, a calculated average wind speed, a weighted average wind speed, and a mathematical average wind speed. By using the expression forms with different wind speeds, the small wind power field can obtain different machine assembling capacity levels. For different installed capacity levels, the power generation and power generation amount of the small wind farm are also often different in different seasons, optimally leading to different wind energy utilization rates of the small wind power stations, different power generation device utilization rates, and different maximum years of utilization hours of the power generation device.

Under a constant wind speed or a slowly varying wind speed, both an active power control method for a wind power generator set based on closed-loop rotational speed control and an active power control method for a wind power generator set based on a pre-set power supply can adjust a fan to a stable equilibrium point. At the operating point, the fan pneumatic power, electromagnetic power, and grid power commands are equal to each other, so that not only the grid power command is responded to, but also the self-electromechanical dynamic stabilization is maintained. Because the fan unit can run at a stable equilibrium point for a long time, the foregoing two methods can achieve an active power control objective, and control performance is similar.

However, in the case of a turbulent wind speed, due to inherent slow dynamic characteristics of a large inertia wind wheel and engineering constraints of a rated capacity of a generator and structural loads of a fan, the fan is difficult to continuously run at a stable equilibrium point, and most of the fans are in dynamic processes of keeping track of the stable equilibrium point and continuously changing speeds. By means of the active power control method for a wind power generator set based on closed-loop rotational speed control and the active power control method for a wind power generator set given based on a pre-set power, the control performance is degraded, and the requirements of a power grid for an offshore wind power supply for desired stable output cannot be satisfied.

### SUMMARY

The main purpose of the present application is to provide a method, device, medium and system for controlling the electric power generation of a wind power generator set based on the Internet of Things, to at least solve the problem in the existing solution that in the case of a turbulent wind speed, a wind power generation unit active power control method based on closed-loop rotational speed control and a wind power generation unit active power control method based on pre-set power are used, the control performance becomes poor, and cannot satisfy the problem that the power grid has a desired stable output requirement for marine wind power supply.

In order to achieve the described purpose, according to one aspect of the present application, provided is a method for controlling a power generation power of an Internet of Things-based wind power generation unit. The method comprises:
Acquiring a first electric power regulation component, a second electric power regulation component and a third electric power regulation component of a wind generator set within a pre-set time period, the first electric power generation power regulation amount component represents a degree of influence of a regulation amount of a gearbox step-up ratio of the wind power generator group on the electric power generation power of the wind power generator group, the second electric power generation power regulation component represents a degree of influence of the generator electromagnetic torque of the wind power generator group on the electric power generated by the wind power generator group, the third electric power generation power regulation amount component represents a degree of influence of a regulation amount of a rotor speed of the wind turbine generator group on an electric power generation power of the wind turbine generator group;
Determining an expected electric power adjustment value at least according to one of the first electric power regulation and control amount component, the second electric power regulation and control amount component and the third electric power regulation and control amount component;
Acquiring a current power generation power, and adjusting the power generation power of the wind generator group to be a difference value between the current power generation power and the expected adjusting value of the power generation power, wherein the current power generation power is the power generation power of the wind generator group in a pre-set time period.

Optionally, the step of acquiring a first electric power regulation component, a second electric power regulation component and a third electric power regulation component of a wind generator set within a pre-set time period comprises:
According to

$$\{ \begin{matrix}Δ {P}_{SWi 1} ( t ) = {k}_{Wi} {n}_{SWi} ( t - 1 ) {T}_{SWGi} ( t - 1 ) Δ {ω}_{SWEi} ( t ) \\ Δ {P}_{SWi 2} ( t ) = {k}_{Wi} {ω}_{SWEi} ( t - 1 ) {n}_{SWi} ( t - 1 ) Δ {T}_{SWGi} ( t ) \\ Δ {P}_{SWi 3} ( t ) = {k}_{Wi} {ω}_{SWEi} ( t - 1 ) {T}_{SWGi} ( t - 1 ) Δ {n}_{SWi} ( t )\end{matrix} ,$$

Determining the first electric power generation power regulation amount component, the second electric power regulation amount component and the third electric power regulation amount component, wherein ΔP_{SWi1}(t), ΔP_{SWi2}(t), ΔP_{SWi3}(t) are the first electric power generation modulation and control amount component, the second electric power generation modulation and control amount component, and the third electric power generation modulation and control amount component of the ith wind power generator group in the t-period, k_{Wi} is a total influence coefficient, and the total influence coefficient comprises an influence coefficient of the wind speed of the wind power generation unit, an influence coefficient of the wind turbulence, an influence coefficient of the wind direction and an influence coefficient of the wind flow, and n_{SWi}(t−1), T_{SWGi}(t−1), ω_{SWEi}(t−1) are a gear box speed increase ratio, a generator electromagnetic torque and a rotor rotation speed of the ith wind turbine set in the t−1 time period, and Δn_{SWi}(t), ΔT_{SWGi}(t), Δω_{SWEi}(t) are the regulation amount of the gearbox step-up ratio, the regulation amount of the generator electromagnetic torque, and the regulation amount of the rotating speed of the wind turbine in the ith wind turbine set in the t period.

Optionally, before the acquiring a first electric power adjustment component, a second electric power adjustment component and a third electric power adjustment component of a wind generator set within a pre-set time period, the method further comprises: Determining the total influence coefficient to be a product of a influence coefficient of a wind velocity of the wind power generation unit, a influence coefficient of the cut-out intermittent wind, a influence coefficient of the wind direction, a influence coefficient of the cut-out wind amount, and a influence coefficient of an offshore wind energy conversion efficiency.

Optionally, the acquiring current power generation power includes:
According to

$${P}_{SWi} ( t ) = {k}_{Wi} {k}_{Ci} \frac{{D}_{i} {A}_{i} {v}_{i}^{3}}{2} + {k}_{SWi 1} ( t ) Δ {P}_{SWi 1} ( t ) + {k}_{SWi 2} ( t ) Δ {P}_{SWi 2} ( t ) + {k}_{SWi 3} ( t ) Δ {P}_{SWi 3} ( t ) ,$$

Determining the current power generation power, wherein P_{SWi}(t) is the current power generation power is the current power generation power of the ith wind turbine generator set, and k_{Wi}, k_{Ci} are the total influence coefficient of the ith wind turbine generator set and the influence coefficient of the efficiency of converting wind energy at sea, and k_{SWi1}(t), k_{SWi2}(t), k_{SWi3}(t) are a regulation coefficient of a gearbox step-up ratio, a regulation coefficient of an electromagnetic torque of a generator, and a regulation coefficient of a rotating speed of a wind turbine of the ith wind turbine set in the t period, Dᵢ is the air density of the ith wind turbine generator set, and Aᵢ is the swept area of the ith wind turbine generator set, vᵢ is the air speed of the ith air motor group.

Optionally, the determining an expected electric power adjustment value according to the first electric power generation power regulation component comprises:
Determining an adjustment coefficient of the gearbox step-up ratio according to a range of a wind speed adjustment amount of the wind power generator set in a t-period;
According to ΔP_{SWi1}(t)=k_{SWi1}(t)Δ\tilde{P}_{SWi1}(t),
Determining the expected adjusting value of the generated power, wherein Δ\tilde{P}_{SWi1}(t) is the expected adjusting value of the generated power of the wind power generator group during a time period t.

Optionally, the determining an expected electric power adjustment value according to the second electric power generation power regulation component comprises:
Determining an adjustment coefficient of the electromagnetic torque of the generator according to a range of a wind speed adjustment amount of the wind power generator group in a t-period;
According to ΔP_{SWi2}(t)=k_{SWi2}(t)Δ\tilde{P}_{SWi2}(t),
Determining the expected adjusting value of the generated power, wherein Δ\tilde{P}_{SWi2}(t) is the expected adjusting value of the generated power of the wind power generator group during a time period t.

Optionally, the determining an expected electric power adjustment value according to the third electric power regulation component comprises:
Determining an adjustment coefficient of the rotation speed of the impeller according to a range where a wind speed adjustment amount of the wind turbine generator set is located;
According to ΔP_{SWi3}(t)=k_{SWi3}(t)Δ\tilde{P}_{SWi3}(t),
Determining the expected adjusting value of the generated power, wherein Δ\tilde{P}_{SWi3}(t) is the expected adjusting value of the generated power of the wind power generator group during a time period t.

According to another aspect of the present application, provided is a power generation control device for a wind power generator set based on the Internet of Things. The device comprises:
A first obtaining unit, configured to obtain a first electric power control amount component, a second electric power control amount component, and a third electric power control amount component of a wind generator set within a preset period of time, the first electric power generation power regulation amount component represents a degree of influence of a regulation amount of a gearbox step-up ratio of the wind power generator group on the electric power generation power of the wind power generator group, the second electric power generation power regulation component represents a degree of influence of the generator electromagnetic torque of the wind power generator group on the electric power generated by the wind power generator group, the third electric power generation power regulation amount component represents a degree of influence of a regulation amount of a rotor speed of the wind turbine generator group on an electric power generation power of the wind turbine generator group;
A determining unit, configured to determine an expected electric power adjustment value at least according to one of the first electric power regulation and control amount component, the second electric power regulation and control amount component, and the third electric power regulation and control amount component;
A second acquisition unit for acquiring a current power generation power, and adjusting the power generation power of the wind power generator group to be a difference value between the current power generation power and the expected adjusting value of the power generation power, wherein the current power generation power is the power generation power of the wind power generator group in a pre-set time period.

According to another aspect of the present application, a computer-readable storage medium is provided. The computer-readable storage medium comprises a stored program.

When the program runs, a device where the computer-readable storage medium is located is controlled to execute any one of the methods for controlling the power generation of a wind power generator set based on the Internet of Things.

According to another aspect of the present application, provided is a power generation control system for a wind turbine generator set based on the Internet of Things, the system includes one or more processors, memory, and one or more programs, wherein the one or more programs are stored in the memory, and configured to be executed by the one or more processors, wherein the one or more programs comprise a control method for executing the electric power generation power of any one of the Internet of Things-based wind power generator sets.

By applying the technical solution of the present application, by using at least one of the first, second, and third electric power regulation amount components, determining an expected adjustment value of electric power, so that at least one of a gearbox step-up ratio, an electromagnetic torque of a generator, and a rotation speed of a wind wheel can be calculated to adjust a data security adjustment and control amount of output power of an offshore wind power generator set, finally, adjusting the generated power of the wind turbine generator set to be a difference between the current generated power and the expected adjusted value of the generated power, thus, the accuracy of power generation power adjustment is improved, and the problem in the prior art of turbulent wind speed is solved, adopting a wind power generator set active power control method based on closed-loop rotational speed control and a wind power generator set active power control method based on a pre-set power, the control performance becomes poor, and cannot satisfy the problem that the power grid has a desired stable output requirement for marine wind power supply.

### BRIEF DESCRIPTION OF THE DRAWINGS

The accompanying drawings, which form a part of the present application, are used for providing a further understanding of the present application. The schematic embodiments and illustrations of the present application are used for explaining the present application, and do not form improper limits to the present application. In the drawings:

FIG. 1 shows a hardware structure block diagram of a mobile terminal for executing a method for controlling electric power generation power of an Internet of Things-based wind power generator set according to an embodiment of the present application;

FIG. 2 shows a schematic flowchart of a method for controlling a generated power of a wind turbine generator set based on the Internet of Things according to an embodiment of the present application;

FIG. 3 shows a schematic flowchart of another method for controlling electric power generation capacity of an Internet of Things-based wind power generator set according to an embodiment of the present application; and

FIG. 4 shows a structural block diagram of a device for controlling power generation of a wind turbine generator set based on the Internet of Things according to an embodiment of the present application.

The figures include the following reference signs:
102: processor; 104: storage; 106: transmission equipment; 108: an input/output device.

### DETAILED DESCRIPTION OF EMBODIMENTS

It is important to note that the embodiments of the present disclosure and the characteristics in the embodiments can be combined under the condition of no conflicts. The present disclosure will be described below with reference to the drawings and examples in detail.

To make persons skilled in the art better understand the solutions of the present application, the following clearly and completely describes the technical solutions in the embodiments of the present application with reference to the accompanying drawings in the embodiments of the present application. Apparently, the described embodiments are merely a part rather than all of the embodiments of the present application. All other examples obtained by a person of ordinary skill in the art based on the embodiments of the present application without creative efforts shall belong to the scope of protection of the present application.

It should be noted that the terms “first” and “second” in the specification, claims, and accompanying drawings of the present application are used to distinguish similar objects, and are not necessarily used to describe a specific sequence or order. It should be understood that the data so used may be interchanged where appropriate for the embodiments of the present application described herein. In addition, the terms “include” and “have”, and any variations thereof, are intended to cover a non-exclusive inclusion, for example, a process, method, system, product, or apparatus that includes a series of steps or units is not necessarily limited to those steps or units that are expressly listed, but may include other steps or units that are not expressly listed or inherent to such process, method, product, or apparatus.

As introduced in the background art, in the case of a turbulent wind speed, due to inherent slow dynamic characteristics of a large inertia wind wheel and engineering constraints on rated capacity of a generator and structural load of a fan, the fan is difficult to continuously run at a stable balance point, and is mostly in a dynamic process of tracking the stable balance point and continuously changing speed. Adopting a wind power generator set active power control method based on closed-loop rotational speed control and a wind power generator set active power control method based on a pre-set power, the control performance becomes poor, and cannot meet a demand of a power grid for an offshore wind power supply to achieve a desired stable output. In order to solve the problem of a turbulent wind speed in an existing solution, adopting a wind power generator set active power control method based on closed-loop rotational speed control and a wind power generator set active power control method based on a pre-set power, the control performance becomes poor, and cannot satisfy the problem that the power grid has an expected stable output demand for marine wind power supply, examples of the present application provide a method, an apparatus, a medium, and a system for controlling electric power generation of a wind turbine generator set based on the Internet of Things.

The following clearly and completely describes the technical solutions in the examples of the present invention with reference to the accompanying drawings in the examples of the present invention.

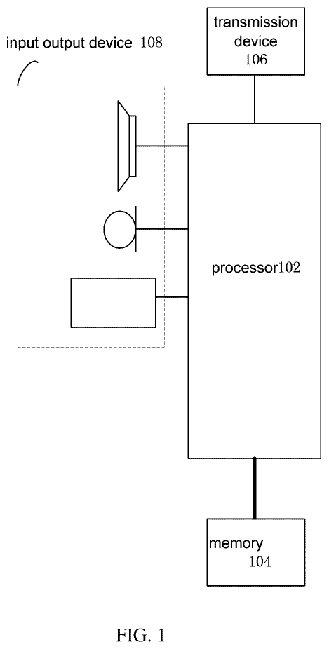

The method examples provided in the examples of the present application may be implemented in a mobile terminal, a computer terminal, or a similar computing apparatus. Taking running on a mobile terminal as an example, FIG. 1 is a hardware structure block diagram of a mobile terminal of a method for controlling power generation of a wind turbine generator set based on the Internet of Things according to an embodiment of the present invention. As shown in FIG. 1, the mobile terminal may include one or more (only one is shown in FIG. 1) processors 102 (the processors 102 may include, but are not limited to, a processing apparatus such as a microprocessor MCU or a programmable logic device FPGA) and a memory 104 for storing data, wherein the mobile terminal can further include a transmission device 106 and an input/output device 108 for a communication function. A person of ordinary skill in the art may understand that the structure shown in FIG. 1 is merely exemplary, which does not limit the structure of the foregoing mobile terminal. For example, the mobile terminal may further include more or less components than shown in FIG. 1, or have a different configuration from that shown in FIG. 1.

The memory 104 may be used for storing a computer program, for example, a software program and module of application software, such as a computer program corresponding to the method for controlling the power generation power of a wind power generator group based on the Internet of Things in the embodiments of the present invention. The processor 102 runs the computer program stored in the memory 104, so as to execute various functional applications and data processing, that is, to implement the foregoing method. Memory 104 may include high-speed random access memory, and may also include non-volatile memory, such as one or more magnetic storage devices, flash memory, or other non-volatile solid-state memory. In some instances, memory 104 may further include memory remotely located with respect to processor 102, which may be connected to mobile terminals over a network. Examples of such networks include, but are not limited to, the internet, intranets, local area networks, mobile communication networks, and combinations thereof. The transmitting device 106 is used to receive or transmit data via a network. Specific examples of the described network may include a wireless network provided by a communication provider of the mobile terminal. In one example, the transfer device 106 may comprise a Network Interface Controller (NIC) that may be coupled to other network devices via a base station to communicate with the Internet. In one example, the transmission device 106 may be a Radio Frequency (RF) module for communicating wirelessly with the internet.

In the present example, a method for controlling the generated power of an Internet of Things-based wind power generator set running on a mobile terminal, a computer terminal or a similar computing apparatus is provided, it should be noted that the steps shown in the flowchart of the drawings can be executed in a computer system such as a group of computer executable instructions, furthermore, although a logic sequence is shown in the flowchart, in some cases, the shown or described steps may be executed in a sequence different from that described here.

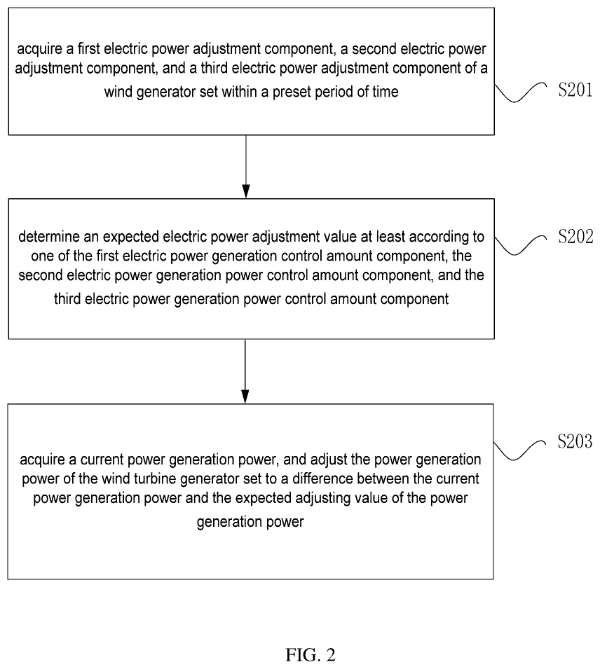

FIG. 2 is a schematic flowchart of a method for controlling generated power of a wind turbine generator set based on the Internet of Things according to an embodiment of the present application. As shown in FIG. 2, the method comprises the following steps:
Step S201, acquiring a first electric power regulation component, a second electric power regulation component and a third electric power regulation component of a wind generator set within a pre-set time period, the first electric power generation power regulation and control quantity component represents a degree of influence of a regulation and control quantity of a gearbox step-up ratio of the described wind power generator group on the electric power generation power of the described wind power generator group, the second electric power generation power regulation component represents a degree of influence of the generator electromagnetic torque of the described wind power generator group on the electric power generated by the described wind power generator group, the third electric power generation power regulation component represents a degree of influence of the regulation and control amount of the rotation speed of the rotor of the wind turbine generator set on the electric power generation of the wind turbine generator set;
Step S201, i.e., acquiring a first electric power control amount component, a second electric power control amount component and a third electric power control amount component of a wind generator set within a pre-set time period, comprising:
According to

$$\{ \begin{matrix}Δ {P}_{SWi 1} ( t ) = {k}_{Wi} {n}_{SWi} ( t − 1 ) {T}_{SWGi} ( t − 1 ) Δ {ω}_{SWEi} ( t ) \\ Δ {P}_{SWi 2} ( t ) = {k}_{Wi} {ω}_{SMEi} ( t − 1 ) {n}_{SWi} ( t − 1 ) Δ {T}_{SWGi} ( t ) \\ Δ {P}_{SWi 3} ( t ) = {k}_{Wi} {ω}_{SWEi} ( t − 1 ) {T}_{SWGi} ( t − 1 ) Δ {n}_{SWi} ( t )\end{matrix} ,$$

Determining the first electric power generation power regulation component, the second electric power regulation component and the third electric power regulation component, wherein ΔP_{SWi1}(t), ΔP_{SWi2}(t), ΔP_{SWi3}(t) are the first electric power generation modulation and control quantity component, the second electric power generation modulation and control quantity component, and the third electric power generation modulation and control quantity component in the t-th stage of the wind turbine generator group, k_{Wi} is a total influence coefficient, and the total influence coefficient comprises an influence coefficient of the wind speed of the described wind power generation unit, an influence coefficient of the wind turbulence, an influence coefficient of the wind direction and an influence coefficient of the wind flow, n_{SWi}(t−1), T_{SWGi}(t−1), ω_{SWEi}(t−1) are a gearbox step-up ratio, an electromagnetic torque of a generator and a rotating speed of a wind turbine in a t−1 stage of the ith wind turbine set, n_{SWi}(t−1), T_{SWGi}(t−1), ω_{SWEi}(t−1) are a regulation amount of a gearbox step-up ratio, a regulation amount of an electromagnetic torque of a generator and a regulation amount of a rotation speed of a wind turbine in the ith wind turbine set in a t-period.

Specifically, calculating a data safety regulation and control amount of the output power of an offshore wind power generator set when three parameters of a gearbox step-up ratio, an electromagnetic torque of a generator and a rotation speed of a wind wheel are adjusted at the same time.

Before obtaining the first electric power adjustment component, the second electric power adjustment component and the third electric power adjustment component of the wind generator set within the pre-set time period in step S201, the method further comprises: And determining the total influence coefficient as a product of the influence coefficient of the wind speed of the described wind power generation unit, the influence coefficient of the described wind turbulence, the influence coefficient of the described wind direction, the influence coefficient of the described wind intake volume and the influence coefficient of the sea wind energy conversion efficiency.

Specifically, considering the influence of wind speed, air density, wind turbulence, wind direction, wind volume, sea waves, etc., the active power control performance of the wind power generation unit is improved, and the demand of the power grid for the marine wind power supply to achieve the desired stable output is met.
Step S202, determining an expected electric power adjustment value at least according to one of the first electric power generation modulation and control quantity component, the second electric power generation power modulation and control quantity component and the third electric power generation power modulation and control quantity component;
Step S202, an expected electric power adjustment value is determined according to the described first electric power regulation component, comprising: Determining an adjustment coefficient of the gearbox step-up ratio according to the range where the wind speed adjustment amount of the described wind power generator set in the t period is located;
According to ΔP_{SWi1}(t)=k_{SWi1}(t)Δ\tilde{P}_{SWi1}(t),
And determining the expected adjusting value of the power generation power, wherein Δ\tilde{P}_{SWi1}(t) is the expected adjusting value of the power generation power of the wind power generator group in the t period is determined.

Specifically, the adjustment coefficient of the gearbox step-up ratio is determined according to

$$\{ \begin{matrix}{k}_{SWi 1} ( t ) ∈ ( 0.8 , 1. ] , 0 \leq Δ v ( t ) \leq {k}_{v 1} v ( t − 1 ) \\ {k}_{SWi 1} ( t ) ∈ ( 0.5 , 0.8 ] , {k}_{v 1} v ( t − 1 ) < Δ v ( t ) \leq {k}_{v 2} v ( t − 1 ) \\ {k}_{SWi 1} ( t ) ∈ ( 0.3 , 0.5 ] , {k}_{v 2} v ( t − 1 ) < Δ v ( t ) \leq {k}_{v 3} v ( t − 1 ) \\ {k}_{SWi 1} ( t ) ∈ [ 0 , 0.3 ] , {k}_{v 3} v ( t − 1 ) < Δ v ( t ) \leq {k}_{v 4} v ( t − 1 ) , and Δ v ( t )\end{matrix}$$

is the wind speed adjustment amount of the wind power generation unit in the t-period, and kᵥ₁, kᵥ₂, kᵥ₃, kᵥ₄ are a wind speed boundary coefficient of a region where the wind power generation unit is located, and the value range is 0≤kᵥ₁<kᵥ₂<kᵥ₃<kᵥ₄<3, and v(t−1) is the wind speed of the wind power generation unit in the t−1 period.

Step S202, determining an expected electric power adjustment value according to the described second electric power regulation component, comprising:
Determining an adjustment coefficient of the electromagnetic torque of the generator according to a range of a wind speed adjustment amount of the wind power generator group in a t-period;
According to ΔP_{SWi2}(t)=k_{SWi2}(t)Δ\tilde{P}_{SWi2}(t),
And determining the expected adjusting value of the power generation power, wherein Δ\tilde{P}_{SWi2}(t) is the expected adjusting value of the power generation power of the wind power generator group in the t period is determined.

Specifically, the adjustment coefficient of the described generator electromagnetic torque is determined according to

$$\{ \begin{matrix}{k}_{SWi 2} ( t ) ∈ [ 0 , 0.3 ] , 0 \leq Δ v ( t ) \leq {k}_{v 1} v ( t − 1 ) \\ {k}_{SWi 2} ( t ) ∈ ( 0.3 , 0.5 ] , {k}_{v 1} v ( t − 1 ) < Δ v ( t ) \leq {k}_{v 2} v ( t − 1 ) \\ {k}_{SWi 2} ( t ) ∈ ( 0.5 , 0.8 ] , {k}_{v 2} v ( t − 1 ) < Δ v ( t ) \leq {k}_{v 3} v ( t − 1 ) \\ {k}_{SWi 2} ( t ) ∈ ( 0.8 , 1. ] , {k}_{v 3} v ( t − 1 ) < Δ v ( t ) \leq {k}_{v 4} v ( t − 1 )\end{matrix} .$$

Step S202, an expected electric power adjustment value is determined according to the described third electric power regulation component, comprising:
Determining an adjustment coefficient of the rotation speed of the impeller according to a range in which a wind speed adjustment amount of the wind turbine generator set is located;
According to ΔP_{SWi3}(t)=k_{SWi3}(t)Δ\tilde{P}_{SWi3}(t),
And determining the expected adjusting value of the power generation power, wherein Δ\tilde{P}_{SWi3}(t) is the expected adjusting value of the power generation power of the wind power generator group in the t period is determined.

Specifically, an adjustment coefficient of the rotation speed of the impeller is determined according to

$$\{ \begin{matrix}{k}_{SWi 3} ( t ) ∈ [ 0 , 0.3 ] , 0 \leq Δ v ( t ) \leq {k}_{v 1} v ( t − 1 ) \\ {k}_{SWi 3} ( t ) ∈ ( 0.3 , 0.5 ] , {k}_{v 1} v ( t − 1 ) < Δ v ( t ) \leq {k}_{v 2} v ( t − 1 ) \\ {k}_{SWi 3} ( t ) ∈ ( 0.5 , 0.8 ] , {k}_{v 2} v ( t − 1 ) < Δ v ( t ) \leq {k}_{v 3} v ( t − 1 ) \\ {k}_{SWi 3} ( t ) ∈ ( 0.8 , 1. ] , {k}_{v 3} v ( t − 1 ) < Δ v ( t ) \leq {k}_{v 4} v ( t − 1 )\end{matrix} .$$

Firstly determining an adjustment coefficient of the described wind wheel rotation speed according to a range where a wind speed adjustment amount of a wind power generator set is located, and then calculating an expected power generation adjustment value according to the adjustment coefficient of the wind wheel rotation speed and a corresponding regulation amount component, so as to improve the accuracy of subsequent power generation power adjustment.

If two of them are considered, the respective obtained power generation power expected adjustment values are averaged, and the average value is taken as the final power generation electric power expected adjustment value, thereby improving the accuracy of the adjustment.

Step S203, acquiring a current power generation power, and adjusting the power generation power of the described wind power generator group to be a difference value between the described current power generation power and the described power generation power expected adjustment value, wherein the described current power generation power is the power generation power of the described wind power generator group in a pre-set time period.

In the above-described steps, at least one of the first electric power generation modulation component, the second electric power generation modulation component, and the third electric power generation modulation component is used, determining an expected adjustment value of electric power, so that at least one of a gearbox step-up ratio, an electromagnetic torque of a generator, and a rotation speed of a wind wheel can be calculated to adjust a data security adjustment and control amount of output power of an offshore wind power generator set, finally, adjusting the generated power of the described wind power generator group to be the difference value between the described current generated power and the described expected adjusting value of the generated power, thus, the accuracy of power generation power adjustment is improved, and the problem in the prior art of turbulent wind speed is solved, adopting a wind power generator set active power control method based on closed-loop rotational speed control and a wind power generator set active power control method based on a pre-set power, the control performance becomes poor, and cannot satisfy the problem that the power grid has a desired stable output requirement for marine wind power supply.

The step S203 of acquiring the current generated power includes:

According to

$${P}_{SWi} ( t ) = {k}_{Wi} {k}_{Ci} \frac{{D}_{i} {A}_{i} {v}_{i}^{3}}{2} + {k}_{SWi 1} ( t ) Δ {P}_{SWi 1} ( t ) + {k}_{SWi 2} ( t ) Δ {P}_{SWi 2} ( t ) + {k}_{SWi 3} ( t ) Δ {P}_{SWi 3} ( t ) ,$$

Determining the current power generation power, wherein P_{SWi}(t) is the current power generation power is the current power generation power of the ith wind turbine generator set, k_{Wi}, k_{Ci} are the coefficient of influence of the described total influence coefficient and the efficiency of converting wind energy at sea of the ith wind turbine, and k_{SWi1}(t), k_{SWi2}(t), k_{SWi3}(t) are a regulation coefficient of a gearbox step-up ratio, a regulation coefficient of an electromagnetic torque of a generator, and a regulation coefficient of a rotating speed of a wind turbine of the ith wind turbine set in the t-stage, Dᵢ is the air density of the air motor group on the ith table, and Aᵢ is the swept area of the air motor group on the ith table, vᵢ is the air speed of the ith air motor group.

Specifically, the swept area of the ith air motor group is determined according to

$${A}_{i} = \frac{π {R}_{i}^{2}}{2} ,$$

where Ri is the length of the fan blades of the ith air motor group, by taking into account the adjustment coefficient of the gearbox step-up ratio, the adjustment coefficient of the generator electromagnetic torque, and the adjustment coefficient of the wind wheel rotational speed, and the described total influence coefficient of the described wind power generator group on the ith platform, and the influence coefficient of the efficiency of converting wind energy at sea, calculating the current generated power of the ith wind turbine generator set, which can reduce an absolute value of a difference value between the current generated power and an actual value, thus, the calculated current generated power is closer to the actual value, and the subsequent adjustment of the generated power is more accurate.

When the speed increase ratio of the gearbox, the electromagnetic torque of the generator and the rotation speed of the wind wheels are cooperatively adjusted, information sharing of the Internet of Things can be used to perform data security management on the output power of the offshore wind turbine generator set.

Calculating a data safety regulation and control amount of the output power of an offshore wind power generator set when three parameters of a gearbox step-up ratio, an electromagnetic torque of a generator and a rotation speed of a wind wheel are adjusted at the same time. The method for sharing and dynamically controlling wind power generation data in the Internet of Things takes into account the influence of wind speed, air density, wind turbulence, wind direction, wind volume, sea wave, etc., improves the performance of active power control of a wind power generation unit, satisfies the demand of a power grid for stable expected output of wind power at sea, provides theoretical guidance for grid scheduling and power generation control, and provides necessary technical support for new energy generation and intelligent grid scheduling operation.

In order to enable a person skilled in the art to understand the technical solutions of the present application more clearly, the implementation process of the method for controlling electric power generation power of an Internet of Things-based wind power generator set of the present application will be described in detail below in conjunction with specific embodiments.

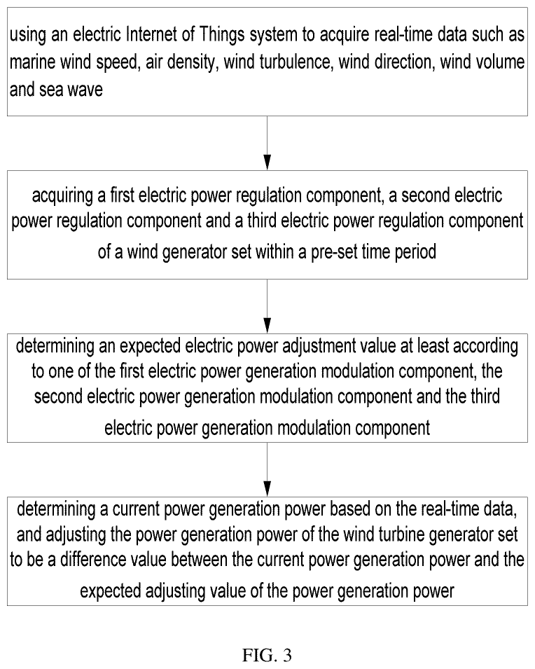

The present embodiment relates to a specific method for controlling a power generation power of a wind power generator set based on the Internet of Things. As shown in FIG. 3, the method comprises the following steps:
Step S1: based on the process and method for collecting wind energy data of an offshore wind power generator set of an electric power Internet of Things, using an electric power Internet of Things system to acquire real-time data such as an offshore wind speed, air density, wind breaking, wind direction, wind volume, and sea wave;
Step S2: acquiring a first electric power regulation component, a second electric power regulation component and a third electric power regulation component of a wind generator set within a pre-set time period, the first electric power generation power regulation and control quantity component represents a degree of influence of a regulation and control quantity of a gearbox step-up ratio of the described wind power generator group on the electric power generation power of the described wind power generator group, the second electric power generation power regulation component represents a degree of influence of the generator electromagnetic torque of the described wind power generator group on the electric power generated by the described wind power generator group, the third electric power generation power regulation component represents a degree of influence of the regulation and control amount of the rotation speed of the rotor of the wind turbine generator set on the electric power generation of the wind turbine generator set;
Step S3: determining an expected electric power adjustment value at least according to one of the first electric power generation control amount component, the second electric power generation power control amount component and the third electric power generation power control amount component;
Step S4: determining a current power generation power based on the described real-time data, and adjusting the power generation power of the described wind power generator group to be a difference value between the described current power generation power and the described power generation power expected adjustment value, wherein the described current power generation power is the power generation power of the described wind power generator group in a pre-set time period.

By referring to at least one of the first electric power generation control amount component, the second electric power generation power control amount component, and the third electric power generation power control amount component, determining an expected adjustment value of electric power, so that at least one of a gearbox step-up ratio, an electromagnetic torque of a generator, and a rotation speed of a wind wheel can be calculated to adjust a data security adjustment and control amount of output power of an offshore wind power generator set, finally, adjusting the generated power of the described wind power generator group to be the difference value between the described current generated power and the described expected adjusting value of the generated power, thus, the accuracy of power generation power adjustment is improved, and the problem in the prior art of turbulent wind speed is solved, adopting a wind power generator set active power control method based on closed-loop rotational speed control and a wind power generator set active power control method based on a pre-set power, the control performance becomes poor, and cannot satisfy the problem that the power grid has a desired stable output requirement for marine wind power supply.

It should be noted that, the steps shown in the flowchart of the drawings can be executed in a computer system such as a set of computer executable instructions, and although the logic order is shown in the flowchart, in some cases, the shown or described steps can be executed in an order different from that described here.

An example of the present application further provides an Internet of Things-based apparatus for controlling power generation of a wind power generator set. It should be noted that, the apparatus for controlling power generation of a wind power generator set based on an Internet of Things-based manner in the embodiment of the present application can be used to execute the method for controlling power generation of a wind power generator set based on an Internet of Things-based manner provided in the example of the present application. The device is configured to implement the described example and example implementation mode, and what has been described will not be elaborated. The term “module”, as used hereinafter, is a combination of software and/or hardware capable of realizing a predetermined function. Although the apparatus described in the following example is preferably implemented by software, implementation of hardware or a combination of software and hardware is also possible and conceived.

The following introduces a device for controlling power generation of a wind turbine generator set based on the Internet of Things according to embodiments of the present application.

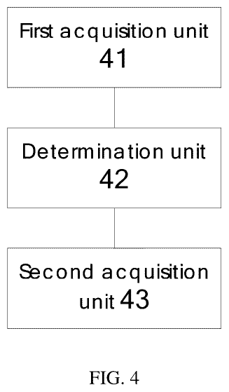

FIG. 4 is a structural block diagram of a device for controlling power generation of a wind turbine generator set based on the Internet of Things according to an embodiment of the present disclosure. As shown in FIG. 4, the device comprises: A first obtaining unit 41, configured to obtain a first electric power control amount component, a second electric power control amount component, and a third electric power control amount component of a wind generator group within a preset period of time, the first electric power generation power regulation and control quantity component represents a degree of influence of a regulation and control quantity of a gearbox step-up ratio of the described wind power generator group on the electric power generation power of the described wind power generator group, the second electric power generation power regulation component represents a degree of influence of the generator electromagnetic torque of the described wind power generator group on the electric power generated by the described wind power generator group, the third electric power generation power regulation component represents a degree of influence of the regulation and control amount of the rotation speed of the rotor of the wind turbine generator set on the electric power generation of the wind turbine generator set;
A determining unit 42, configured to determine an expected electric power adjustment value at least according to one of the first electric power generation modulation component, the second electric power generation modulation component, and the third electric power generation modulation component;
A second acquiring unit 43, configured to acquire a current power generation power, and adjust the power generation power of the described wind power generator group to be a difference value between the current power generation power and the described expected adjustment value of the power generation power, wherein the current power generation power is the power generation power of the described wind power generator group in a pre-set time period.

In the above-described apparatus, at least one of the first electric power adjustment control amount component, the second electric power adjustment control amount component, and the third electric power adjustment control amount component is used, determining an expected adjustment value of electric power, so that at least one of a gearbox step-up ratio, an electromagnetic torque of a generator, and a rotation speed of a wind wheel can be calculated to adjust a data security adjustment and control amount of output power of an offshore wind power generator set, finally, adjusting the generated power of the described wind power generator group to be the difference value between the described current generated power and the described expected adjusting value of the generated power, thus, the accuracy of power generation power adjustment is improved, and the problem in the prior art of turbulent wind speed is solved, adopting a wind power generator set active power control method based on closed-loop rotational speed control and a wind power generator set active power control method based on a pre-set power, the control performance becomes poor, and cannot satisfy the problem that the power grid has a desired stable output requirement for marine wind power supply.

In an example of the present disclosure, the first acquisition unit includes a first determination module,

The first determination module is configured to

$$\{ \begin{matrix}Δ {P}_{SWi 1} ( t ) = {k}_{Wi} {n}_{SWi} ( t − 1 ) {T}_{SWGi} ( t − 1 ) Δ {ω}_{SWEi} ( t ) \\ Δ {P}_{SWi 2} ( t ) = {k}_{Wi} {ω}_{SMEi} ( t − 1 ) {n}_{SWi} ( t − 1 ) Δ {T}_{SWGi} ( t ) \\ Δ {P}_{SWi 3} ( t ) = {k}_{Wi} {ω}_{SWEi} ( t − 1 ) {T}_{SWGi} ( t − 1 ) Δ {n}_{SWi} ( t )\end{matrix} ,$$

Determining the first electric power generation power regulation component, the second electric power regulation component and the third electric power regulation component, wherein ΔP_{SWi1}(t), ΔP_{SWi2}(t), ΔP_{SWi3}(t), are the first electric power generation modulation and control quantity component, the second electric power generation modulation and control quantity component, and the third electric power generation modulation and control quantity component in the t-th stage of the wind turbine generator group, k_{Wi} is a total influence coefficient, and the total influence coefficient comprises an influence coefficient of the wind speed of the described wind power generation unit, an influence coefficient of the wind turbulence, an influence coefficient of the wind direction and an influence coefficient of the wind flow, n_{SWi}(t−1), T_{SWGi}(t−1), ω_{SWEi}(t−1) are a gearbox step-up ratio, an electromagnetic torque of a generator and a rotating speed of a wind turbine in a t−1 stage of the ith wind turbine set, Δn_{SWi}(t), ΔT_{SWGi}(t), Δω_{SWEi}(t) are the regulation amount of the gearbox step-up ratio, the regulation amount of the generator electromagnetic torque, and the regulation amount of the rotating speed of the wind turbine in the ith wind turbine set in the t period.

In an example of the present disclosure, the device further includes a processing unit, which is configured to, before acquiring the first electric power regulation component, the second electric power regulation component and the third electric power regulation component of the wind generator set within the pre-set time period,

The processing unit is configured to determine that the total influence coefficient is a product of the influence coefficient of the wind speed of the described wind power generation unit, the influence coefficient of the described wind turbulence, the influence coefficient of the described wind direction, the influence coefficient of the described wind intake volume and the influence coefficient of the described wind energy conversion efficiency at sea.

In an example of the present disclosure, the second acquisition unit includes a second determination module;
The second determination module is configured to

$${P}_{SWi} ( t ) = {k}_{Wi} {k}_{Ci} \frac{{D}_{i} {A}_{i} {v}_{i}^{3}}{2} + {k}_{SWi 1} ( t ) Δ {P}_{SWi 1} ( t ) + {k}_{SWi 2} ( t ) Δ {P}_{SWi 2} ( t ) + {k}_{SWi 3} ( t ) Δ {P}_{SWi 3} ( t ) ,$$

Determining the current power generation power, wherein P_{SWi}(t) is the current power generation power is the current power generation power of the ith wind turbine generator set, k_{Wi}, k_{Ci} is the coefficient of influence of the described total influence coefficient and the efficiency of converting wind energy at sea of the ith wind turbine, and k_{SWi1}(t), k_{SWi2}(t), k_{SWi3}(t) are a regulation coefficient of a gearbox step-up ratio, a regulation coefficient of an electromagnetic torque of a generator, and a regulation coefficient of a rotating speed of a wind turbine of the ith wind turbine set in the t-stage, Dᵢ is the air density of the air motor group on the ith table, and Aᵢ is the swept area of the air motor group on the ith table, vᵢ is the air speed of the ith air motor group.

In an example of the present disclosure, the determination unit includes a third determination module and a fourth determination module,
A third determination module for determining an adjustment coefficient of the gearbox step-up ratio according to the range where the air speed adjustment amount of the described wind power generator group in the t period is located;
The fourth determination module is configured to ΔP_{SWi1}(t)=k_{SWi1}(t)Δ\tilde{P}_{SWi1}(t),
And determining the expected adjusting value of the power generation power, wherein Δ\tilde{P}_{SWi1}(t) is the expected adjusting value of the power generation power of the wind power generator group in the t period is determined.

In an example of the present disclosure, the determination unit includes a fifth determination module and a sixth determination module,
A fifth determination module for determining an adjustment coefficient of the electromagnetic torque of the generator according to the range where the wind speed adjustment amount of the described wind power generator group in the t period is located;
The sixth determination module is configured to ΔP_{SWi2}(t)=k_{SWi2}(t)Δ\tilde{P}_{SWi2}(t),
And determining the expected adjusting value of the power generation power, wherein Δ\tilde{P}_{SWi2}(t) is the expected adjusting value of the power generation power of the wind power generator group in the t period is determined.

In an example of the present disclosure, the determining unit includes a seventh determining module and an eighth determining module,
A seventh determining module, configured to determine an adjustment coefficient of the rotation speed of the impeller according to a range in which a wind speed adjustment amount of the wind turbine generator set is located;
The eighth determining module is configured to ΔP_{SWi3}(t)=k_{SWi3}(t)Δ\tilde{P}_{SWi3}(t),
And determining the expected adjusting value of the power generation power, wherein Δ\tilde{P}_{SWi3}(t) is the expected adjusting value of the power generation power of the wind power generator group in the t period is determined.

The above-mentioned power generation control device for a wind power generator group based on the Internet of Things comprises a processor and a memory, wherein the described first acquisition unit, determination unit and second acquisition unit are all stored in the memory as program units, and the processor executes the described program units stored in the memory to realize corresponding functions. All the described modules are located in the same processor; alternatively, the modules are located in different processors in an arbitrary combination.

The processor includes a kernel, and the kernel calls a corresponding program unit from a memory. One or more inner cores may be provided, and the inner core parameters are adjusted to solve the problem in the existing solution that in the case of a turbulent wind speed, a wind power generation unit active power control method based on closed-loop rotational speed control and a wind power generation unit active power control method based on a preset power are used, the control performance becomes poor, and the demand of a power grid for an offshore wind power supply to achieve the desired stability and productivity cannot be satisfied.

The memory may include a non-permanent memory in a computer readable medium, a random access memory (RAM), and/or a non-volatile memory, such as a read-only memory (ROM) or a flash RAM, and the memory includes at least one memory chip.

Examples of the present invention provide a computer readable storage medium. The computer readable storage medium comprises a stored program. When the program runs, a device in which the computer readable storage medium is located is controlled to execute the method for controlling the generation power of an Internet of Things-based fan motor group.

Examples of the present invention provide a processor. The processor is used for running a program. The program, when running, executes the method for controlling power generation of a wind power generation unit based on the Internet of Things.

Provided is a device. The device comprises a processor, a memory and a program which is stored in the memory and can run on the processor, when a processor executes a program, at least the following steps are realized: acquiring a first electric power regulation amount component, a second electric power regulation amount component and a third electric power regulation amount component of a wind generator set within a pre-set time period, the first electric power generation power regulation and control quantity component represents a degree of influence of a regulation and control quantity of a gearbox step-up ratio of the described wind power generator group on the electric power generation power of the described wind power generator group, the second electric power generation power regulation component represents a degree of influence of the generator electromagnetic torque of the described wind power generator group on the electric power generated by the described wind power generator group, the third electric power generation power regulation component represents a degree of influence of the regulation and control amount of the rotation speed of the rotor of the wind turbine generator set on the electric power generation of the wind turbine generator set; determining an expected electric power adjustment value at least according to one of the first electric power generation modulation component, the second electric power generation modulation component, and the third electric power generation modulation component; acquiring a current power generation power, and adjusting the power generation power of the described wind power generator group to be a difference value between the described current power generation power and the described power generation power expected adjustment value, wherein the described current power generation power is the power generation power of the described wind power generator group in a pre-set time period. The device herein may be a server, a PC, a PAD, a mobile phone, etc.

Optionally, the step of acquiring a first electric power regulation component, a second electric power regulation component and a third electric power regulation component of a wind generator set within a pre-set time period comprises:
According to

$$\{ \begin{matrix}Δ {P}_{SWi 1} ( t ) = {k}_{Wi} {n}_{SWi} ( t − 1 ) {T}_{SWGi} ( t − 1 ) Δ {ω}_{SWEi} ( t ) \\ Δ {P}_{SWi 2} ( t ) = {k}_{Wi} {ω}_{SMEi} ( t − 1 ) {n}_{SWi} ( t − 1 ) Δ {T}_{SWGi} ( t ) \\ Δ {P}_{SWi 3} ( t ) = {k}_{Wi} {ω}_{SWEi} ( t − 1 ) {T}_{SWGi} ( t − 1 ) Δ {n}_{SWi} ( t )\end{matrix} ,$$

Determining the first electric power generation power regulation amount component, the second electric power regulation amount component and the third electric power regulation amount component, wherein ΔP_{SWi1}(t), ΔP_{SWi2}(t), ΔP_{SWi3}(t), are the first electric power generation modulation and control amount component, the second electric power generation modulation and control amount component, and the third electric power generation modulation and control amount component of the ith wind power generator group in the t-period, k_{Wi} is a total influence coefficient, and the total influence coefficient comprises an influence coefficient of the wind speed of the wind power generation unit, an influence coefficient of the wind turbulence, an influence coefficient of the wind direction and an influence coefficient of the wind flow, and n_{SWi}(t−1), T_{SWGi}(t−1), ω_{SWEi}(t−1), are a gear box speed increase ratio, a generator electromagnetic torque and a rotor rotation speed of the ith wind turbine set in the t−1 time period, and Δn_{SWi}(t), ΔT_{SWGi}(t), Δω_{SWEi}(t) are the regulation amount of the gearbox step-up ratio, the regulation amount of the generator electromagnetic torque, and the regulation amount of the rotating speed of the wind turbine in the ith wind turbine set in the t period.

Optionally, before the acquiring a first electric power adjustment component, a second electric power adjustment component and a third electric power adjustment component of a wind generator set within a pre-set time period, the method further comprises:
Determining the total influence coefficient to be a product of a influence coefficient of a wind velocity of the wind power generation unit, a influence coefficient of the cut-out intermittent wind, a influence coefficient of the wind direction, a influence coefficient of the cut-out wind amount, and a influence coefficient of an offshore wind energy conversion efficiency.

Optionally, the acquiring current power generation power includes:
According to

$${P}_{SWi} ( t ) = {k}_{Wi} {k}_{Ci} \frac{{D}_{i} {A}_{i} {v}_{i}^{3}}{2} + {k}_{SWi 1} ( t ) Δ {P}_{SWi 1} ( t ) + {k}_{SWi 2} ( t ) Δ {P}_{SWi 2} ( t ) + {k}_{SWi 3} ( t ) Δ {P}_{SWi 3} ( t ) ,$$

Determining the current power generation power, wherein P_{SWi}(t) is the current power generation power is the current power generation power of the ith wind turbine generator set, and k_{Wi}, k_{Ci} are the total influence coefficient of the ith wind turbine generator set and the influence coefficient of the efficiency of converting wind energy at sea, and k_{SWi1}(t), k_{SWi2}(t), k_{SWi3}(t), are a regulation coefficient of a gearbox step-up ratio, a regulation coefficient of an electromagnetic torque of a generator, and a regulation coefficient of a rotating speed of a wind turbine of the ith wind turbine set in the t period, Dᵢ is the air density of the ith wind turbine generator set, and Aᵢ is the swept area of the ith wind turbine generator set, vᵢ is the air speed of the ith air motor group.

Optionally, the determining an expected electric power adjustment value according to the first electric power generation power regulation component comprises:
Determining an adjustment coefficient of the gearbox step-up ratio according to a range of a wind speed adjustment amount of the wind power generator set in a t-period;
According to ΔP_{SWi1}(t)=k_{SWi1}(t)Δ\tilde{P}_{SWi1}(t),
Determining the expected adjusting value of the generated power, wherein Δ\tilde{P}_{SWi1}(t) is the expected adjusting value of the generated power of the wind power generator group during a time period t.

Optionally, the determining an expected electric power adjustment value according to the second electric power generation power regulation component comprises:
Determining an adjustment coefficient of the electromagnetic torque of the generator according to a range of a wind speed adjustment amount of the wind power generator group in a t-period;
According to ΔP_{SWi2}(t)=k_{SWi2}(t)Δ\tilde{P}_{SWi2}(t),
Determining the expected adjusting value of the generated power, wherein Δ\tilde{P}_{SWi2}(t) is the expected adjusting value of the generated power of the wind power generator group during a time period t.

Optionally, the determining an expected electric power adjustment value according to the third electric power regulation component comprises:
Determining an adjustment coefficient of the rotation speed of the impeller according to a range where a wind speed adjustment amount of the wind turbine generator set is located;
According to ΔP_{SWi3}(t)=k_{SWi3}(t)Δ\tilde{P}_{SWi3}(t),
Determining the expected adjusting value of the generated power, wherein Δ\tilde{P}_{SWi3}(t) is the expected adjusting value of the generated power of the wind power generator group during a time period t.

The present application further provides a computer program product. The computer program product, when executed on a data processing device, is suitable for executing a program for initializing at least the following method steps: acquiring a first electric power regulation amount component, a second electric power regulation amount component and a third electric power regulation amount component of a wind turbine generator set within a pre-set time period, the first electric power generation power regulation and control quantity component represents a degree of influence of a regulation and control quantity of a gearbox step-up ratio of the described wind power generator group on the electric power generation power of the described wind power generator group, the second electric power generation power regulation component represents a degree of influence of the generator electromagnetic torque of the described wind power generator group on the electric power generated by the described wind power generator group, the third electric power generation power regulation component represents a degree of influence of the regulation and control amount of the rotation speed of the rotor of the wind turbine generator set on the electric power generation of the wind turbine generator set; determining an expected electric power adjustment value at least according to one of the first electric power generation modulation component, the second electric power generation modulation component, and the third electric power generation modulation component; acquiring a current power generation power, and adjusting the power generation power of the described wind power generator group to be a difference value between the described current power generation power and the described power generation power expected adjustment value, wherein the described current power generation power is the power generation power of the described wind power generator group in a pre-set time period.

Optionally, the step of acquiring a first electric power regulation component, a second electric power regulation component and a third electric power regulation component of a wind generator set within a pre-set time period comprises:
According to

$$\{ \begin{matrix}Δ {P}_{SWi 1} ( t ) = {k}_{Wi} {n}_{SWi} ( t − 1 ) {T}_{SWGi} ( t − 1 ) Δ {ω}_{SWEi} ( t ) \\ Δ {P}_{SWi 2} ( t ) = {k}_{Wi} {ω}_{SMEi} ( t − 1 ) {n}_{SWi} ( t − 1 ) Δ {T}_{SWGi} ( t ) \\ Δ {P}_{SWi 3} ( t ) = {k}_{Wi} {ω}_{SWEi} ( t − 1 ) {T}_{SWGi} ( t − 1 ) Δ {n}_{SWi} ( t )\end{matrix} ,$$

Determining the first electric power generation power regulation amount component, the second electric power regulation amount component and the third electric power regulation amount component, wherein ΔP_{SWi1}(t), ΔP_{SWi2}(t), ΔP_{SWi3}(t), are the first electric power generation modulation and control amount component, the second electric power generation modulation and control amount component, and the third electric power generation modulation and control amount component of the ith wind power generator group in the t-period, k_{Wi} is a total influence coefficient, and the total influence coefficient comprises an influence coefficient of the wind speed of the wind power generation unit, an influence coefficient of the wind turbulence, an influence coefficient of the wind direction and an influence coefficient of the wind flow, and n_{SWi}(t−1), T_{SWGi}(t−1), ω_{SWEi}(t−1) are a gear box speed increase ratio, a generator electromagnetic torque and a rotor rotation speed of the ith wind turbine set in the t−1 time period, and Δn_{SWi}(t), ΔT_{SWGi}(t), Δω_{SWEi}(t) are the regulation amount of the gearbox step-up ratio, the regulation amount of the generator electromagnetic torque, and the regulation amount of the rotating speed of the wind turbine in the ith wind turbine set in the t period.

Optionally, before the acquiring a first electric power adjustment component, a second electric power adjustment component and a third electric power adjustment component of a wind generator set within a pre-set time period, the method further comprises:
Determining the total influence coefficient to be a product of a influence coefficient of a wind velocity of the wind power generation unit, a influence coefficient of the cut-out intermittent wind, a influence coefficient of the wind direction, a influence coefficient of the cut-out wind amount, and a influence coefficient of an offshore wind energy conversion efficiency.

Optionally, the acquiring current power generation power includes:
According to

$${P}_{SWi} ( t ) = {k}_{Wi} {k}_{Ci} \frac{{D}_{i} {A}_{i} {v}_{i}^{3}}{2} + {k}_{SWi 1} ( t ) Δ {P}_{SWi 1} ( t ) + {k}_{SWi 2} ( t ) Δ {P}_{SWi 2} ( t ) + {k}_{SWi 3} ( t ) Δ {P}_{SWi 3} ( t ) ,$$

Determining the current power generation power, wherein P_{SWi}(t) is the current power generation power is the current power generation power of the ith wind turbine generator set, and k_{Wi}, k_{Ci} are the total influence coefficient of the ith wind turbine generator set and the influence coefficient of the efficiency of converting wind energy at sea, and k_{SWi1}(t), k_{SWi2}(t), k_{SWi3}(t) are a regulation coefficient of a gearbox step-up ratio, a regulation coefficient of an electromagnetic torque of a generator, and a regulation coefficient of a rotating speed of a wind turbine of the ith wind turbine set in the t period, Dᵢ is the air density of the ith wind turbine generator set, and Aᵢ is the swept area of the ith wind turbine generator set, vᵢ is the air speed of the ith air motor group.

Optionally, the determining an expected electric power adjustment value according to the first electric power generation power regulation component comprises:
Determining an adjustment coefficient of the gearbox step-up ratio according to a range of a wind speed adjustment amount of the wind power generator set in a t-period;
According to ΔP_{SWi1}(t)=k_{SWi1}(t)Δ\tilde{P}_{SWi1}(t),
Determining the expected adjusting value of the generated power, wherein Δ\tilde{P}_{SWi1}(t) is the expected adjusting value of the generated power of the wind power generator group during a time period t.

Optionally, the determining an expected electric power adjustment value according to the second electric power generation power regulation component comprises:
Determining an adjustment coefficient of the electromagnetic torque of the generator according to a range of a wind speed adjustment amount of the wind power generator group in a t-period;
According to ΔP_{SWi2}(t)=k_{SWi2}(t)Δ\tilde{P}_{SWi2}(t),
Determining the expected adjusting value of the generated power, wherein Δ\tilde{P}_{SWi2}(t) is the expected adjusting value of the generated power of the wind power generator group during a time period t.

Optionally, the determining an expected electric power adjustment value according to the third electric power regulation component comprises:
Determining an adjustment coefficient of the rotation speed of the impeller according to a range where a wind speed adjustment amount of the wind turbine generator set is located;
According to ΔP_{SWi3}(t)=k_{SWi3}(t)Δ\tilde{P}_{SWi3}(t),
Determining the expected adjusting value of the generated power, wherein Δ\tilde{P}_{SWi3}(t) is the expected adjusting value of the generated power of the wind power generator group during a time period t.

The present application also provides a power generation control system for a wind power generation unit based on the Internet of Things. The system comprises: one or more processors, a memory, and one or more programs, wherein the one or more programs are stored in the memory, and is configured to be executed by the one or more processors. The one or more programs comprise a control method for executing any one of the described wind power generation methods based on the Internet of Things. By referring to at least one of the first electric power generation control amount component, the second electric power generation power control amount component, and the third electric power generation power control amount component, determining an expected adjustment value of electric power, so that at least one of a gearbox step-up ratio, an electromagnetic torque of a generator, and a rotation speed of a wind wheel can be calculated to adjust a data security adjustment and control amount of output power of an offshore wind power generator set, finally, adjusting the generated power of the described wind power generator group to be the difference value between the described current generated power and the described expected adjusting value of the generated power, thus, the accuracy of power generation power adjustment is improved, and the problem in the prior art of turbulent wind speed is solved, adopting a wind power generator set active power control method based on closed-loop rotational speed control and a wind power generator set active power control method based on a pre-set power, the control performance becomes poor, and cannot satisfy the problem that the power grid has a desired stable output requirement for marine wind power supply.

Obviously, those skilled in the art should understand that the described modules and steps of the present invention can be realized by a universal computing device, they may be centralized on a single computing device or distributed on a network composed of a plurality of computing devices, they can be implemented by program codes executable by a computing apparatus, and thus can be stored in a storage apparatus and executed by the computing apparatus, furthermore, in some cases, the shown or described steps may be executed in an order different from that described here, or they are made into integrated circuit modules respectively, or a plurality of modules or steps therein are made into a single integrated circuit module for implementation. Thus, the present invention is not limited to any specific combination of hardware and software.

Those skilled in the art shall understand that the embodiments of the present application can be provided as a method, a system or a computer program product. Therefore, the present disclosure may take the form of an entirely hardware example, an entirely software example or an example combining software and hardware. Furthermore, the present application may take the form of a computer program product implemented on one or more computer-usable storage media (including but not limited to a disk memory, a CD-ROM, an optical memory, etc.) containing computer-usable program codes.

The present application is described with reference to the flowcharts and/or block diagrams of the method, device (system), and computer program product according to the examples of the present application. It should be understood that each flow and/or block in the flowcharts and/or block diagrams and combinations of flows and/or blocks in the flowcharts and/or block diagrams can be implemented by computer program instructions. These computer program instructions may be provided to a processor of a general purpose computer, a special purpose computer, an embedded processor or other programmable data processing apparatus to produce a machine, an apparatus that enables instructions executed by a processor of a computer or other programmable data processing devices to generate the functions specified in one or more processes in the flowcharts and/or one or more blocks in the block diagrams.

These computer program instructions may also be stored in a computer-readable memory capable of guiding a computer or other programmable data processing apparatuses to work in a specific manner, so that the instructions stored in the computer-readable memory generate a manufactured product comprising an instruction apparatus, and the instruction apparatus implements functions specified in one or more flows in the flowchart and/or one or more blocks in the block diagram.

These computer program instructions may also be loaded onto a computer or another programmable data processing device, causing a series of operational steps to be performed on a computer or other programmable apparatus to produce a computer implemented process, thus, the instructions executed on the computer or other programmable devices provide steps for implementing the functions specified in one or more processes in the flowcharts and/or one or more blocks in the block diagrams.

In a typical configuration, the computing device includes one or more processors (CPUs), an input/output interface, a network interface, and memory.

The memory may include a non-permanent storage in a computer readable medium, a random access memory (RAM), and/or a non-volatile memory, such as a read-only memory (ROM) or a flash RAM. A memory is an example of a computer-readable medium.

Computer-readable media, including both persistent and non-persistent, removable and non-removable media, may implement information storage by any method or technology. The information may be computer readable instructions, data structures, modules of a program, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disc read-only memory (CD-ROM), digital versatile discs (DVD) or other optical storage, magnetic cassettes, magnetic tape, magnetic disk storage or other magnetic storage devices, or any other non-transmission medium, may be used to store information that may be accessed by a computing device. As defined herein, computer-readable media does not include transitory computer-readable media, such as modulated data signals and carrier waves.

It should also be noted that the terms “include”, “include”, or any other variation thereof are intended to cover a non-exclusive inclusion, so that a process, a method, a commodity, or a device that includes a series of elements not only includes those elements, but also includes other elements that are not explicitly listed, or further includes inherent elements of the process, the method, the commodity, or the device. Without further limitation, an element limited by “include a . . . ” does not exclude other same elements existing in a process, a method, a commodity, or a device that includes the element.

From the above description, it can be seen that the above embodiments of the present application achieve the following technical effects:
1) The method for controlling a power generation power of a wind power generation unit based on the Internet of Things of the present application, comprising: according to at least one of the first power generation regulation and control amount component, the second power generation regulation and control amount component, and the third power generation regulation and control amount component, determining an expected adjustment value of electric power, so that at least one of a gearbox step-up ratio, an electromagnetic torque of a generator, and a rotation speed of a wind wheel can be calculated to adjust a data security adjustment and control amount of output power of an offshore wind power generator set, finally, adjusting the generated power of the described wind power generator group to be the difference value between the described current generated power and the described expected adjusting value of the generated power, thus, the accuracy of power generation power adjustment is improved, and the problem in the prior art of turbulent wind speed is solved, adopting a wind power generator set active power control method based on closed-loop rotational speed control and a wind power generator set active power control method based on a pre-set power, the control performance becomes poor, and cannot satisfy the problem that the power grid has a desired stable output requirement for marine wind power supply.
2) The device for controlling electric power generation of an Internet of Things-based wind power generator set of the present application, comprising at least one of the first electric power generation regulation component, the second electric power generation regulation component and the third electric power regulation component, determining an expected adjustment value of electric power, so that at least one of a gearbox step-up ratio, an electromagnetic torque of a generator, and a rotation speed of a wind wheel can be calculated to adjust a data security adjustment and control amount of output power of an offshore wind power generator set, finally, adjusting the generated power of the described wind power generator group to be the difference value between the described current generated power and the described expected adjusting value of the generated power, thus, the accuracy of power generation power adjustment is improved, and the problem in the prior art of turbulent wind speed is solved, adopting a wind power generator set active power control method based on closed-loop rotational speed control and a wind power generator set active power control method based on a pre-set power, the control performance becomes poor, and cannot satisfy the problem that the power grid has a desired stable output requirement for marine wind power supply.

The foregoing descriptions are merely exemplary embodiments of the present application, but are not intended to limit the present application. For those skilled in the art, the present application may have various modifications and variations. Any modifications, equivalent replacements, improvements and the like made within the spirit and principle of the present application shall belong to the scope of protection of the present application.

What is claimed is:

1. A power generation control method for a wind power generator set based on the Internet of Things, the method comprising:
acquiring a first electric power regulation component, a second electric power regulation component and a third electric power regulation component of a wind generator set within a pre-set time period, the first electric power generation power regulation amount component represents a degree of influence of a regulation amount of a gearbox step-up ratio of the wind power generator group on the electric power generation power of the wind power generator group, the second electric power generation power regulation component represents a degree of influence of the generator electromagnetic torque of the wind power generator group on the electric power generated by the wind power generator group, the third electric power generation power regulation amount component represents a degree of influence of a regulation amount of a rotor speed of the wind turbine generator group on an electric power generation power of the wind turbine generator group;
determining an expected electric power adjustment value at least according to one of the first electric power regulation and control amount component, the second electric power regulation and control amount component and the third electric power regulation and control amount component; and
acquiring a current power generation power, and adjusting the power generation power of the wind generator group to be a difference value between the current power generation power and the expected adjusting value of the power generation power, wherein the current power generation power is the power generation power of the wind generator group in a pre-set time period.

2. The method according to claim 1, wherein the acquiring a first electric power adjustment component, a second electric power adjustment component, and a third electric power adjustment component of a wind turbine generator set within a preset period of time comprises:
according to
$$\{ \begin{matrix}Δ {P}_{SWi 1} ( t ) = {k}_{Wi} {n}_{SWi} ( t − 1 ) {T}_{SWGi} ( t − 1 ) Δ {ω}_{SWEi} ( t ) \\ Δ {P}_{SWi 2} ( t ) = {k}_{Wi} {ω}_{SMEi} ( t − 1 ) {n}_{SWi} ( t − 1 ) Δ {T}_{SWGi} ( t ) \\ Δ {P}_{SWi 3} ( t ) = {k}_{Wi} {ω}_{SWEi} ( t − 1 ) {T}_{SWGi} ( t − 1 ) Δ {n}_{SWi} ( t )\end{matrix} ,$$
determining the first electric power generation power regulation amount component, the second electric power regulation amount component and the third electric power regulation amount component, wherein ΔP_{SWi1}(t), ΔP_{SWi2}(t), ΔP_{SWi3}(t) are the first electric power generation modulation and control amount component, the second electric power generation modulation and control amount component, and the third electric power generation modulation and control amount component of the ith wind power generator group in the t-period, k_{Wi} is a total influence coefficient, and the total influence coefficient comprises an influence coefficient of the wind speed of the wind power generation unit, an influence coefficient of the wind turbulence, an influence coefficient of the wind direction and an influence coefficient of the wind flow, and n_{SWi}(t−1), T_{SWGi}(t−1), ω_{SWEi}(t−1) are a gear box speed increase ratio, a generator electromagnetic torque and a rotor rotation speed of the ith wind turbine set in the t−1 time period, and Δn_{SWi}(t), ΔT_{SWGi}(t), Δω_{SWEi}(t) are a regulation amount of a gearbox step-up ratio, a regulation amount of an electromagnetic torque of a generator, and a regulation amount of a rotating speed of a wind turbine in a t-stage of the ith wind turbine set, Dᵢ is the air density of the ith wind turbine generator set, and Aᵢ is the swept area of the ith wind turbine generator set, vᵢ is the air speed of the ith air motor group.

3. The method according to claim 2, wherein before obtaining the first electric power adjustment component, the second electric power adjustment component and the third electric power adjustment component of the wind turbine generator set within the pre-set time period, the method further comprises:
determining the total influence coefficient to be a product of a influence coefficient of a wind velocity of the wind power generation unit, a influence coefficient of the cut-out intermittent wind, a influence coefficient of the wind direction, a influence coefficient of the cut-out wind amount, and a influence coefficient of an offshore wind energy conversion efficiency.

4. The method according to claim 2, wherein that acquiring the current generated power comprises:
according to
$${P}_{SWi} ( t ) = {k}_{Wi} {k}_{Ci} \frac{{D}_{i} {A}_{i} {v}_{i}^{3}}{2} + {k}_{SWi 1} ( t ) Δ {P}_{SWi 1} ( t ) + {k}_{SWi 2} ( t ) Δ {P}_{SWi 2} ( t ) + {k}_{SWi 3} ( t ) Δ {P}_{SWi 3} ( t ) ,$$
determining the current power generation power, wherein, P_{SWi}(t) is the current power generation power of the ith wind turbine generator set, k_{Wi} is the total influence coefficient of the ith wind turbine generator set, and k_{Ci} is an influence coefficient of an offshore wind energy conversion efficiency, k_{SWi1}(t) is an adjustment coefficient of a gearbox step-up ratio of the ith wind turbine generator set during a t period, k_{SWi2}(t) is an adjustment coefficient of a generator electromagnetic torque, and k_{SWi3}(t) is an adjustment coefficient of a wind wheel rotation speed.

5. The method according to claim 4, wherein that the step of determining an expected adjustment value of electric power based on the first electric power generation control amount component comprises:
determining an adjustment coefficient of the gearbox step-up ratio according to a range of a wind speed adjustment amount of the wind power generator set in a t-period;
according to ΔP_{SWi1}(t)=k_{SWi1}(t)Δ\tilde{P}_{SWi1}(t), determining the expected adjusting value of the generated power, wherein Δ\tilde{P}_{SWi1}(t) is the expected adjusting value of the generated power of the wind power generator group during a time period t.

6. The method according to claim 4, wherein that the step of determining an expected electric power adjustment value according to the second electric power generation control amount component comprises:
determining an adjustment coefficient of the electromagnetic torque of the generator according to a range of a wind speed adjustment amount of the wind power generator group in a t-period;
according to ΔP_{SWi2}(t)=k_{SWi2}(t)Δ\tilde{P}_{SWi2}(t), determining the expected adjusting value of the generated power, wherein Δ\tilde{P}_{SWi2}(t) is the expected adjusting value of the generated power of the wind power generator group during a time period t.

7. The method according to claim 4, wherein that the step of determining an expected adjustment value of electric power based on the third electric power regulation component comprises:
determining an adjustment coefficient of the rotation speed of the impeller according to a range where a wind speed adjustment amount of the wind turbine generator set is located;
according to ΔP_{SWi3}(t)=k_{SWi3}(t)Δ\tilde{P}_{SWi3}(t), determining the expected adjusting value of the generated power, wherein Δ\tilde{P}_{SWi3}(t) is the expected adjusting value of the generated power of the wind power generator group during a time period t.

8. A computer readable storage medium, characterized in that the computer readable storage medium comprises a stored program, wherein when the program runs, a device where the computer readable storage medium is located is controlled to execute the method for controlling the electric power generation capacity of an Internet of Things-based wind power generator set according to claim 1.

9. An Internet of Things-based system for controlling electric power generation of a wind turbine generator set, comprising: one or more processors, a memory, and one or more programs, wherein the one or more programs are stored in the memory, and configured to be executed by the one or more processors, wherein the one or more programs comprise a control method for executing the electric power generation power of the Internet of Things-based wind power generator set according to claim 1.
